(19) United States
(12) Patent Application Publication
(10) Pub. No.: US 2010/0070488 A1
(43) Pub. Date: Mar. 18, 2010

(54) RANKING SEARCH RESULTS BASED ON AFFINITY CRITERIA

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: Nortel Networks Limited, St. Laurent (CA)

(21) Appl. No.: 12/210,047

(22) Filed: Sep. 12, 2008

(51) Int. Cl. G06F 17/30

(52) U.S. Cl. 707/722; 707/E17.071

(57) ABSTRACT

The present invention relates to searching content databases and ranking the search results of the searches based, at least in part, on affinity criteria for a particular user. Notably, a given user will communicate through various means with contacts. The identities of some, if not all, of the contacts with which the user communicates are used to create an affinity list. For each contact in the user's affinity list, a record of the items that have been accessed by that user is maintained as access history information. Each contact may have access history information, and the collection of the access history information for some or all of the contacts in the user's affinity list is generally referred to as affinity criteria. When the user initiates a search for items in contact databases, items returned from the search are ranked based, at least in part, on the affinity criteria.

### CROSS-REFERENCE TO RELATED APPLICATIONS

This application is related to commonly owned and assigned application Se. No. 12/047,138 filed Mar. 12, 2008, the disclosure of which is incorporated herein by reference in its entirety.

### FIELD OF THE INVENTION

The present invention relates to searching content items in response to a search query, and in particular ranking the content items that are returned in response to the search query based on affinity criteria.

### BACKGROUND OF THE INVENTION

The onset of the information age has led to the creation of untold volumes of information. Some of the information is public while some of the information is private. For the most part, the Internet provides the public access to public information while corporate intranets provide employees access to private information. Regardless of the public or private nature of the information, the value of the information is diminished if it is not readily accessible by the public, in the case of public information, or by authorized users, in the case of private information.

For the Internet, search engine providers, such as Google® and Yahoo®, are in a constant battle to provide searchers with the most relevant search results in response to the user's queries. In most instances, the search results for a given search query include more content items than the user can reasonably view. As such, the search engine providers employ ranking criteria to rank the content items in the search results in an effort to the guess the most relevant content items and then present the most relevant content items to the user. Many of the search engines analyze the content items or metadata associated with the content items to predict the most relevant ones of the content items in the search results. For example, content items that contain the most occurrences of the search terms in the body or metadata of the content item are deemed most relevant. In many cases, the frequency with which the search terms are used does not correspond to relevance.

As another example, Google® uses ranking criteria that ranks web pages based on how often the web pages are referred to by other web pages. A web page that is referred to by a large number of other web pages is deemed more relevant, and thus will be ranked higher, than a web page that is referred to by only a few other web pages. This ranking system tends to work well for popular topics, such as entertainment or sports topics, but does not work well for more obscure topics.

Similar search engines exist for searching private content items, such as word processing documents, spread sheets, presentations, publishing documents, and the like, that are stored on intranets of enterprises. Unfortunately, the amount of cross-referencing between these content items is typically low, and thus, the use of cross-referencing to rank search results is of little assistance in predicting the most relevant ones of the content items in the search results.

Given the limitations of existing ranking techniques, there is a need for a technique for ranking search results in a more effective manner.

### SUMMARY OF THE INVENTION

The present invention relates to searching content databases and ranking the search results of the searches based, at least in part, on affinity criteria for a particular user. Notably, a given user will communicate through various means with other parties, who are referred to as “contacts” for clarity. The identities of some, if not all, of the contacts with whom the user communicates are used to create a list of contacts, which is referred to as an affinity list. For each contact in the user's affinity list, a record of the items that have been accessed by that user is maintained as access history information. Each contact may have access history information, and the collection of the access history information for some or all of the contacts in the user's affinity list is generally referred to as affinity criteria. When the user initiates a search for items in content databases, items returned from the search are ranked based, at least in part, on the affinity criteria. The affinity criteria may be combined with other ranking criteria to determine a final ranking of the items returned from the search.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS FIGURES

The accompanying drawing figures incorporated in and forming a part of this specification illustrate several aspects of the invention, and together with the description serve to explain the principles of the invention.

FIG. 1 is a flow diagram outlining the basic operation of one embodiment of the present invention.

FIG. 2 is a block representation of a communication environment according to one embodiment of the present invention.

FIG. 3 is a flow diagram outlining the basic operation of an access history server according to one embodiment of the present invention.

FIG. 4 illustrates access history information according to one embodiment of the present invention.

FIG. 5 is a flow diagram outlining the basic operation of a search server according to one embodiment of the present invention.

FIG. 6 illustrates the ranking of search results without access history information.

FIG. 7 illustrates the ranking of search results with access history information according to one embodiment of the present invention.

FIG. 8 is a flow diagram outlining the basic operation of an affinity server according to one embodiment of the present invention.

FIG. 9 is an alternative block representation of a communication environment according to one embodiment of the present invention.

FIGS. 10A and 10B are a flow diagram illustrating operation of one embodiment of the present invention.

FIG. 11 illustrates communication event ranking criteria according to one embodiment of the present invention.

FIG. 12 illustrates elapsed time ranking criteria according to one embodiment of the present invention.

FIG. 13 illustrates an affinity list according to one embodiment of the present invention.

FIG. 14 illustrates a window from which communications may be initiated according to one embodiment of the present invention.

FIG. 15 illustrates an updated affinity list according to one embodiment of the present invention.

FIG. 16 illustrates affinity data derived from a call log according to one embodiment of the present invention.

FIG. 17 illustrates affinity data derived from email data according to one embodiment of the present invention.

FIG. 18 illustrates an entry from an information database according to one embodiment of the present invention.

FIG. 19 is a block representation of a search server according to one embodiment of the present invention.

FIG. 20 is a block representation of an affinity server according to one embodiment of the present invention.

FIG. 21 is a block representation of an access history server according to one embodiment of the present invention.

FIG. 22 is a block representation of a user terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to searching content databases and ranking the search results of the searches based, at least in part, on affinity criteria for a particular user. Notably, a given user will communicate through various means with other parties, who are referred to as contacts for clarity. The identities of some, if not all, of the contacts with whom the user communicates are used to create a list of contacts, which is referred to as an affinity list. For each contact in the user's affinity list, a record of the items that have been accessed by that user is maintained as access history information. Each contact may have access history information, and the collection of the access history information for some or all of the contacts in the user's affinity list is generally referred to as affinity criteria. Accordingly, the affinity criteria relates to the items that have been accessed by contacts with whom the user has communicated.

When the user initiates a search for items in content databases, items returned from the search are ranked based, at least in part, on the affinity criteria. As such, the ranking of the items in the search results may depend on whether contacts in the user's affinity list have previously accessed those items. All things being equal, items that have been previously accessed by the contacts with whom the user shares an affinity are deemed more relevant than items that have not been accessed by the contacts. The affinity criteria may be combined with other ranking criteria to determine a final ranking of the items returned from the search. The affinity criteria may control the relative ranking of a particular item in the search results based on various factors including, but not limited to, when the item was accessed, what contacts accessed the item, the number of times the item was accessed by one or more of the contacts, when the item was accessed, the nature of the access, or any combination thereof.

Any given user may have multiple affinity lists, each of which corresponds to a different group of contacts. For example, a user may have personal, recreational, project, group, work, and the like affinity lists. Assuming the different affinity lists for the given user have different groups of contacts, the documents that have been accessed by the different groups of contacts will likely differ. Accordingly, each of the affinity lists may be associated with different affinity criteria, and thus, the same items in a given search result may be ranked differently depending on the affinity criteria for the selected affinity list. The user is preferably able to dynamically select the affinity criteria for a desired affinity list to use for ranking the search results for a given search.

In one embodiment, the contacts in the user's affinity list are also ranked based on their communication relevance to the user. The rank of a particular contact in the affinity list may also be incorporated into the affinity criteria, and thus be a further factor in ranking the search results. For example, items accessed by a contact ranked higher in the affinity list may be ranked higher than those items accessed by a contact ranked lower on the affinity list. The ranking of the contacts in the affinity list may be relatively static or dynamically change based on prior communications between the user and the contacts.

The items may be of any media type including, but not limited to, electronic documents, such a word processing document, spreadsheets, and presentations; media files, such as voice, audio, video, and image files; web pages; and the like. Searches for such items may be initiated from various types of applications, including web browsers, and may be implemented by virtually any type of search engine. The concepts of the invention have broad applicability ranging from enterprise applications, where co-workers search for documents on corporate servers, to web-based applications, where members of social networks search for web sites or media content. In any searching application, the concepts of the present invention may play a role in ranking certain items returned from a user's search based on the affinity criteria of the user.

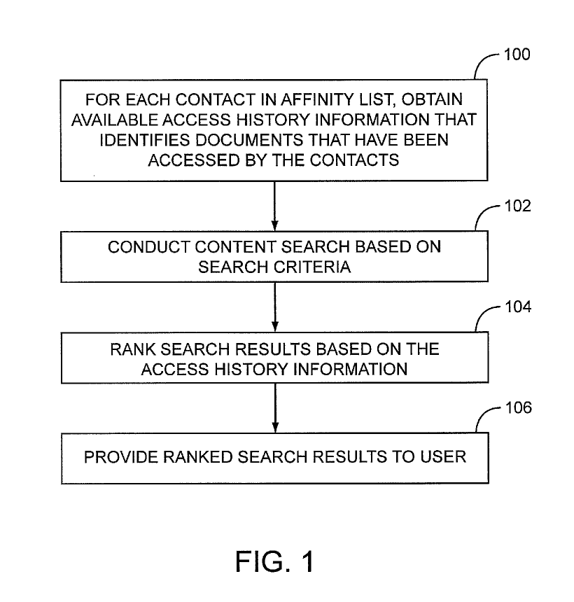

With reference to FIG. 1, a flow diagram illustrating a basic process according to one embodiment of the present invention is shown. Assume that the user is associated with an affinity list. For each of the contacts in the affinity list, available access history information is obtained (step 100). The access history information identifies the documents that have been accessed by the various contacts in the affinity list. Next, a content search is conducted based on search criteria provided by the user (step 102). The search results provided in response to the search are ranked, at least in part, based on any pertinent access history information of the contacts in the affinity list of the user (step 104). The ranked search results are then provided to the user (step 106).

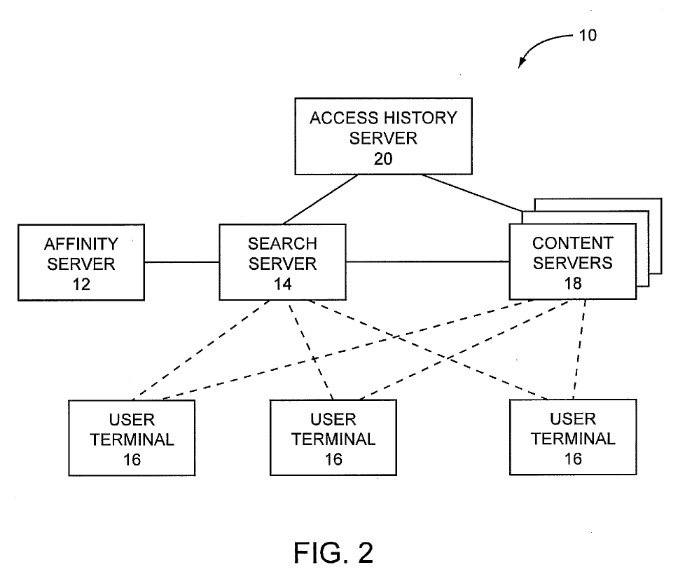

The concepts of the present invention may be implemented in various communication environments, such as the communication environment 10 illustrated in FIG. 2. An affinity server 12 and a search server 14 reside at the center of the communication environment 10. Various user terminals 16, which may take any form including personal computers, personal digital assistants, mobile telephones, and the like, may provide search queries to the search server 14, which will access local information as well as information provided on any number of content servers 18, to fulfill the search query. The search results derived from the local information on the content servers 18 is then ranked using basic ranking criteria, affinity criteria for the user, or a combination thereof. Again, the affinity criteria may represent the access history information for each of the contacts in the user's affinity list. The affinity list for the user may be obtained from the affinity server 12, which maintains either a static or dynamic affinity list for a given user. Alternatively, the search server 14 may maintain the affinity list or retrieve it from the user terminal 16 of the user. The affinity list may be maintained and provided to the search server 14 in various other ways. Once the affinity list is obtained, the search server 14 may obtain the access history information for each of the contacts in the affinity list from an access history server 20. Once the search server 14 has the access history information, search results for the user may be ranked accordingly.

Notably, a graphical user interface, such as a web page, is presented by the user terminal 16 through a browser or dedicated interface application to allow the user to initiate searches. The graphical user interface may be constructed in virtually any manner that allows a search query to be entered and submitted to the search server 14. In one embodiment, the graphical user interface is a web page that allows the user to enter the search criteria and optionally select whether or not the search results should be ranked based on affinity criteria of the user. For example, the web page may have a search query field for entering the search query, a first icon to trigger a search for the search query where the search results are not ranked based on affinity criteria, and a second icon to trigger a search for the search query where the search results are ranked based on affinity criteria. Once the search query is entered in the search query field, the user will select either the first icon or the second icon to initiate the search. The information provided to the search server 14 will include the search query as well as identify which icon was used to initiate the search. The search server 14 may only rank the search results based on the affinity criteria when the second icon is used to initiate the search. As such, the user may readily elect whether or not to have search results ranked based on affinity criteria in association with initiating the search. The search results may be provided to the user via another web page, wherein the search may or may not be ranked based on the affinity criteria depending on whether the user elected to have the search results ranked in a such a manner. In another embodiment, the web page may provide a separate field for the user to populate to indicate whether the search results should be ranked based on the affinity criteria. Those skilled in the art will recognize numerous techniques for allowing the user to dynamically elect to have search resulted ranked based on their affinity criteria.

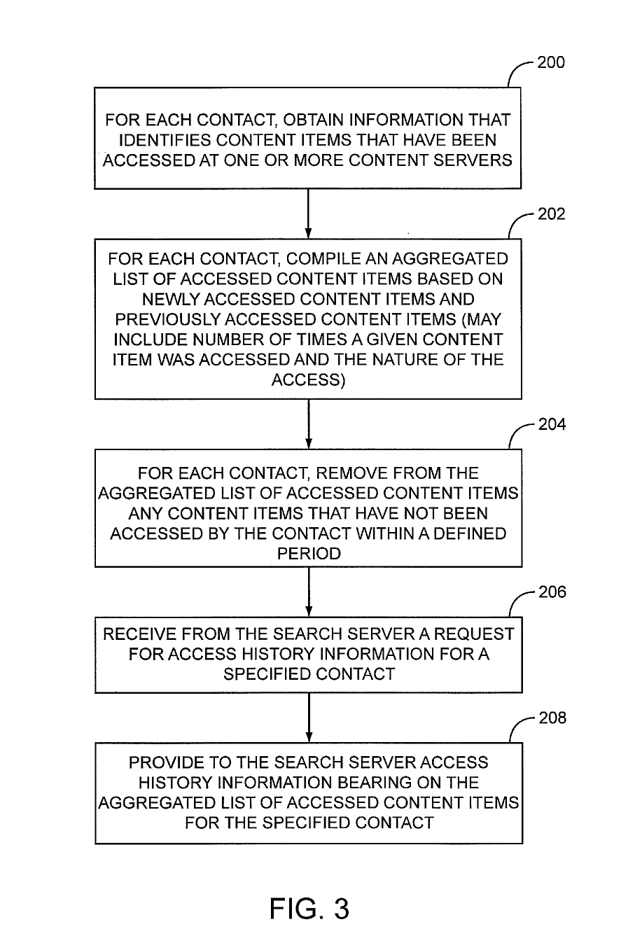

A flow diagram illustrating how access history information is generated by the access history server 20 is provided in FIG. 3. This functionality may be provided in any entity in the communication environment 10, including the search server 14, the content servers 18, or the user terminals 16. In the preferred embodiment, the access history server 20 is an independent function that is capable of interacting with numerous content servers 18 and obtaining information identifying those content items that have been accessed by the various contacts in a user's affinity list. Notably, the access history server 20 need not be aware of a particular affinity list, but will simply keep track of various users in the communication environment 10, wherein a subset of these users may represent the contacts of another user.

In the course of normal access to web sites and in order to facilitate the affinity search, users accessing the web servers may be requested to authenticate themselves via their contact identifier (e.g. c1@abc.com). Alternatively, cookies or other automatic authentication techniques may be used for authentication, if such authentication is desired. Information that identifies content items that have been accessed at one or more of the content servers 18 is obtained for each of the contacts (step 200). The information may be requested by the access history server 20 or may be pushed to the access history server 20 by the corresponding content servers 18 when content items are accessed by the various contacts. For each contact, an aggregated list of the accessed content items is compiled (step 202). Assuming that the aggregated list of content items is dynamically or periodically updated by the access history server 20, the aggregated list of content items will be based on newly accessed content items, which were accessed after the most recent compilation, as well as previously accessed content items, which were considered in a previous compilation. Regardless of how the aggregated list of accessed content items is compiled, the aggregated list for each contact will preferably identify content items that have been accessed by the contact at any number of content servers 18. Further, the aggregated list of content items for the contact may include the number of times a given content item was accessed by the contact and the nature of the access. Similarly, the search server may request the user to authenticate themselves via their contact identifier. Search results URLs that are “clicked-through” are memorized and fed to the access history server 20.

In one embodiment, an aging process is provided, where the aggregated list of accessed content items is processed to remove information that is deemed to have become stale. For example, the aggregated list of accessed content items may not include information identifying those content items that have not been accessed within a certain period of time (step 204). As such, the aggregated list of content items will not identify content items that were accessed more than a week, month, or year ago. Various factors may control the aging process. For example, content items that have been accessed multiple times by one or more contacts may not be removed from the aggregated list of accessed content items as quickly as those content items that have only been accessed one time or a relatively limited number of times.

When the access history server 20 receives a request for access history information for a specified contact (step 206), it will provide to the search server 14 access history information bearing on the aggregated list of accessed content items for the specified contact (step 208). As such, the search server 14 may, periodically or in association with fulfilling a search query for the user, obtain access history information for those contacts in the user's affinity list from the access history server 20. Alternatively, the access history information for a contact may be retrieved from user terminals 16 associated with the contact, the various content servers 18, or other appropriate service node.

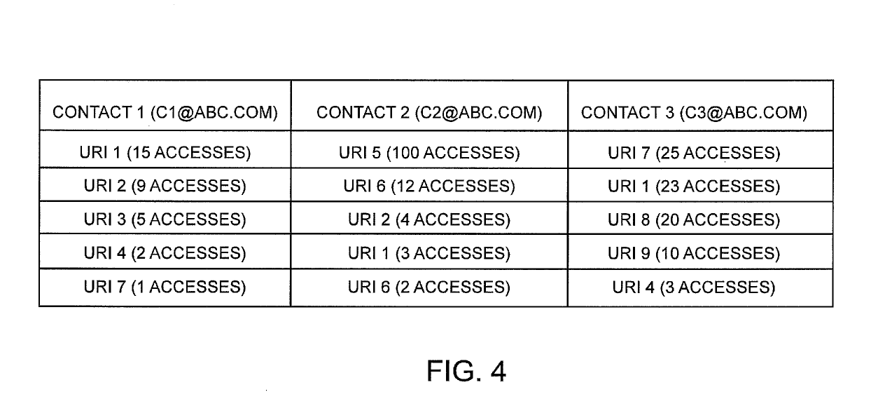

The access history information for three contacts, Contact 1, Contact 2, and Contact 3, is illustrated in FIG. 4. Each of the contacts includes an address, c1@abc.com, c2@abc.com, and c3@abc.com, respectively. The access history information for Contact 1 indicates that Contact 1 has recently accessed URIs (universal resource identifier) 1, 2, 3, 4, and 7, where the URIs identify the content items themselves or an address where the content items are stored, along with the number of times the content items were accessed by the particular contact. In either case, this information is deemed to identify the content items that have been accessed by Contact 1. Similarly, Contact 2 has access history information indicating that Contact 2 has recently accessed content items associated with URIs 5, 6, 2, 1, and 6. Contact 3 has access history information indicating that Contact 3 has recently accessed content items associated with URIs 7, 1, 8, 9, and 4. From the above, the various contacts may have accessed the same or different content items.

In operation, the search server 14 may use the access history information to identify content items that appear in both the access history information and the search results of a particular search query for the user. The use of the affinity criteria may be automatic or based on an indication provided by the user when launching the search. The search server 14 may rank those content items that were returned in a search result and appear in the access history information for one or more of the contacts higher than content items that were returned in a search result and do not appear in the access history information. Notably, the content items that were accessed multiple times by a given contact or by different contacts may be ranked higher than content items that were only accessed once or by a lesser number of contacts. As illustrated in FIG. 4, each of the contacts 1, 2, and 3 accessed the content item associated with URI 1. If the content item associated with URI 1 was returned in the search results, that content item may be ranked relatively high. Contact 1 and Contact 2 both accessed the content item associated with URI 2, and as such, the ranking of the content item associated with URI 2 may follow that of the content item associated with URI 1, assuming both content items associated with URI 1 and URI 2 were returned in the search results. Again, the weighting of the affinity criteria may control the absolute ranking or may factor in with other search criteria used to determine an overall ranking. Accordingly, the affinity criteria need only play a role in the final ranking, and need not dictate the absolute ranking of the search results.

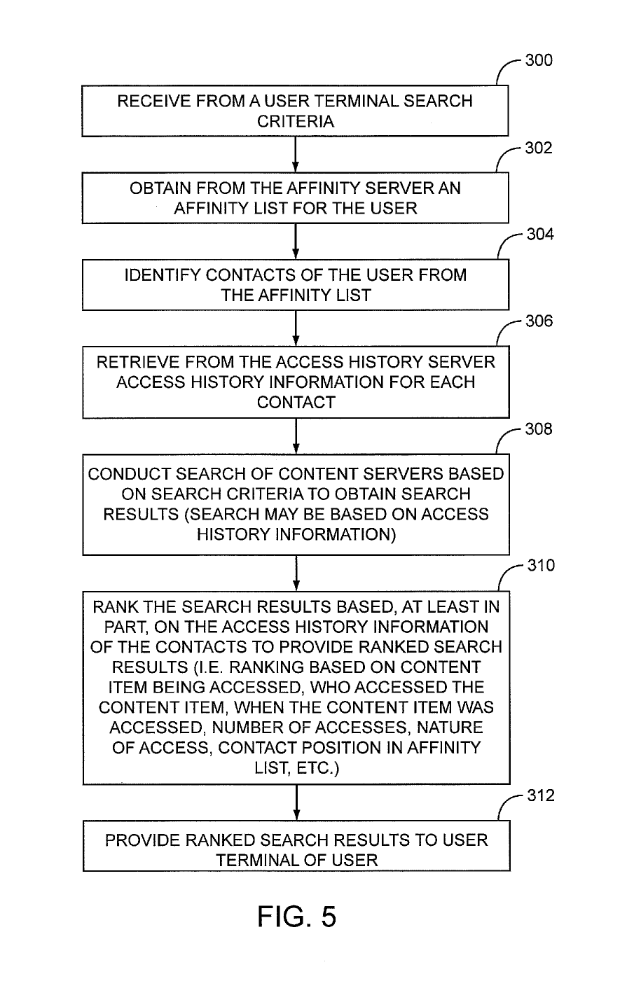

With reference to FIG. 5, a flow diagram is provided to illustrate operation of the search server 14 according to one embodiment of the present invention. Initially, a user at a user terminal 16 may formulate a search query and send the search query toward the search server 14. The search server 14 will receive the search criteria from the user terminal 16 (step 300) and obtain an affinity list for the user from the affinity server 12 (step 302). Notably, information provided by the user may be used to instruct the search server 14 to use affinity criteria when ranking the search results. As such, the search server 14 may only employ the affinity criteria as a factor in ranking the search results for a given search upon request by the user. Alternatively, the search server 14 may be configured to automatically include the affinity criteria in all search results for the user. Further, the user may also provide information identifying a particular affinity list to use for the search, if the user is associated with multiple affinity lists. As such, the user may instruct the search server 14 to use an affinity list associated with a work group for one search, and an affinity list for a personal group for a subsequent search.

Upon receiving the affinity list for the user from the affinity server 12, the search server 14 will identify the contacts of the user from the affinity list (step 304). The search server 14 will then retrieve from the access history server 20 the access history information for each of the contacts in the affinity list (step 306). In the meantime, the search server 14 may conduct a search of the content servers 18 based on the search criteria to obtain search results (step 308). Notably, the access history information may be obtained prior to conducting the search and may be used to conduct the search. As such, the access history information may be used to dictate the raw search results in addition to providing a ranking of the search results. Next, the search results are ranked, at least in part, based on the access history information of the contacts, to provide ranked search results (step 310). Again, the ranking may be based on the content item being accessed, what contact accessed the content item, the number of accesses of the content item, the nature of the access of the content item, when the content item was accessed, as well as the position of the contact in the affinity list. Notably, the nature of the access may indicate whether the item was only opened, opened and edited, played, forwarded, and the like. Those skilled in the art will recognize various other ways in which the search results may be ranked based on the access history information, the affinity list, and the like. Once the ranked search results are generated, they are sent to the user terminal 16 of the user (step 312).

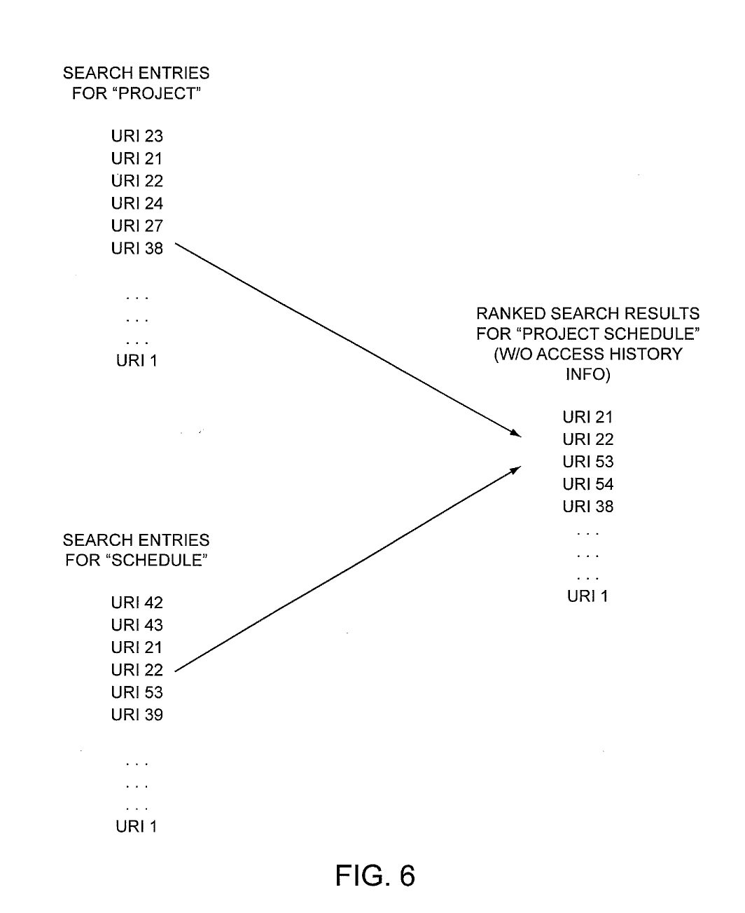

With reference to FIG. 6, a ranking scenario is illustrated according to one embodiment of the present invention. Assume that the search query is configured to search for content item entries that include or are associated with the terms “project” and “schedule.” Further assume that these content item entries are searched individually and the search server 14 processes these individual results to obtain the overall search results. As such, assume that the search for “project” returns the following list of URIs: URI 23, URI 21, URI 22, URI 24, URI 27, URI 38, . . . , URI 1. Similarly, assume that the search for “schedule” returns the following URIs: URI 42, URI 43, URI 21, URI 22, URI 53, URI 39, . . . , URI 1. The search server 14 will process each of these lists to determine the content items that are associated with both “project” and “schedule.” The ranked search results are provided in FIG. 6 without the assistance of affinity criteria, and in particular without the use of access history information for each of the contacts in the user's affinity list. As such, those content items associated with URIs that are ranked relatively high in each of the respective entries for “project” and “schedule” appear high in the ranked search results. In particular, the content items associated with URIs 21 and 22 appear relatively high in the individual entries for “project” and “schedule.” Notably, the content item associated with URI 1 is ranked low in each of the entries for “project” and “schedule,” and as such, is ranked low in the ranked search results.

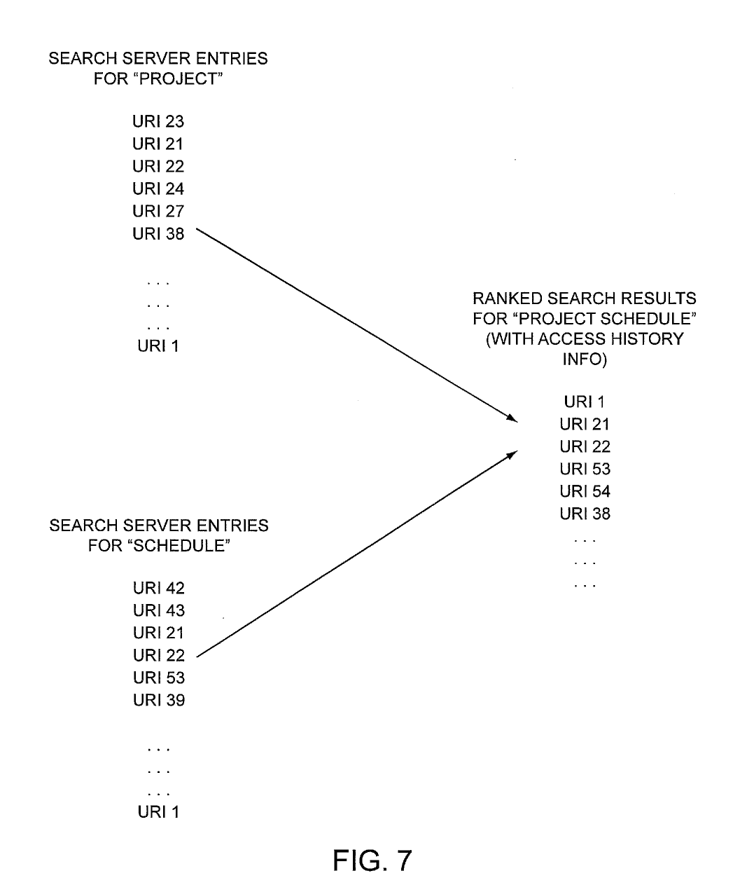

For the ranked search results shown in FIG. 6, the affinity criteria is not used. In one example, assume that the content item associated with URI 1 is a document that is routinely accessed by contacts of the user. Further assume that the content items associated with URIs 21 and 22 have not been accessed by contacts of the user. If this is the case, the content item associated with URI 1 is arguably more relevant to the user than the content items associated with URIs 21 and 22. Regardless of the relative ranking of the content item associated with URI 1 relative to the content items associated with URIs 21 and 22, the content item associated with URI 1 should most likely be ranked much higher in the ranked search results than that depicted in FIG. 6. With reference to FIG. 7, the ranked search results are provided in light of available affinity criteria, and in particular in relation to the available access history information for the contacts of the user's affinity list. Since several of the contacts in the user's affinity list have accessed the content item associated with URI 1, the content item associated with URI 1 is ranked high in the ranked search results, and in particular is ranked higher than those content items that have not been accessed by the contacts in the user's affinity list. Again, those skilled in the art will recognize that the affinity criteria need only factor into the overall ranking of the search results, and the examples provided in FIGS. 6 and 7 are merely provided to illustrate the overall concepts of the present invention.

As indicated above, the contacts in the affinity list may be relatively static or dynamic and may be provided by the user terminal 16, affinity server 12, or other service node. The following description provides an overview of how the affinity server 12 generates a dynamic affinity list of contacts for a given user. In this affinity list, the contacts are ranked based on communication relevance. In particular, this embodiment of the present invention analyzes communications involving a given user and determines a ranked list of the most relevant contacts for the user based on the analysis. As subsequent communications are analyzed, the affinity list may be updated in a systematic fashion to provide a dynamic and up-to-date ranking of the most relevant contacts for the user at any given time. By having access to an up-to-date, ranked list of their most relevant contacts. The affinity list may be used by the search server 14 to assist in ranking search results for the user. The affinity list may also be used by the user to readily initiate communications with others and avoid searching or sorting through more traditional contact listings, as provided in co-pending U.S. patent application Ser. No. 12/047,138 filed Mar. 12, 2008, which is incorporated herein by reference in its entirety.

In this embodiment, the contacts in the ranked list of contacts will include parties who have been involved in a communication event with the user, and perhaps parties who are likely to be involved in communication events with the user. As noted above, the ranked list of contacts is a generally referred to as an affinity list. Information associated with the communication events and used to generate the affinity list is referred to as affinity data. The affinity data may include contact information that identifies those contacts involved in the communication events with the user, and perhaps communication information that pertains to some aspect of the communication event. For example, the communication information may identify the date, time, type, or nature of the communication event.

The types of communication events may include, but are not limited to, a direct telephony call, conference call, instant message, email, social network interaction, web site visitation, virtual world interaction, or the like. Further, a communication event may include different entities coming into proximity or contact with one another in a real or virtual world environment. The nature of a communication event may relate to whether the communication event is initiated or received by the user, how many parties participated in the communication event, the relative importance of the user in the communication event, and the like.

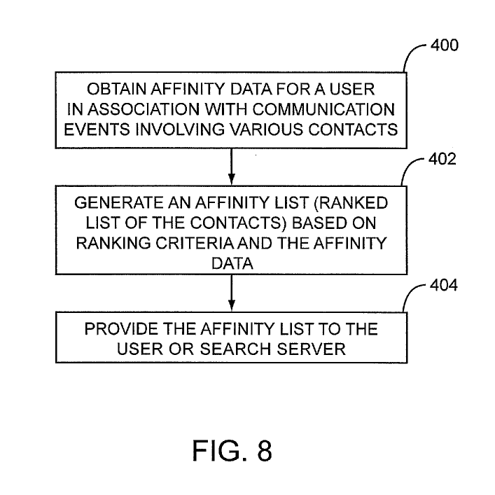

With reference to FIG. 8, a high-level flow diagram is provided to illustrate generation of an affinity list according to this embodiment of the present invention. Initially, affinity data for a user is obtained in association with communication events involving various contacts (step 400). Different events may be associated with different contacts, and certain events may be associated with multiple contacts. An affinity list is generated based on defined ranking criteria and the affinity data (step 402). Once the affinity list is generated, it is provided to the user, a third party, or both (step 404). Once an original affinity list is generated, affinity data for subsequent communication events may be obtained and used to generate an updated affinity list. In a systematic fashion, updated affinity lists may be provided to the search server 14 on a periodic basis, or as the affinity list changes.

In one embodiment, the ranking criteria tends to prioritize those contacts with whom the user most frequently communicates, those contacts with whom the user has most recently communicated, or a combination thereof. In many instances, a user's most relevant contacts are those with whom the user often communicates, or with whom the user has recently communicated. As such, the ranking criteria may be configured to take these factors into consideration when analyzing the affinity data and generating the original or updated affinity list.

Preferably, the user is able to customize the ranking criteria such that different factors may be taken into consideration and given different relative priorities. Notably, a given user may be associated with different affinity lists, which have different ranking criteria. For example, a user may have a different affinity list generated for different roles. As such, the user may have a work affinity list, a personal affinity list, a special project affinity list, and the like. Additional information pertaining to the ranking criteria is described further below.

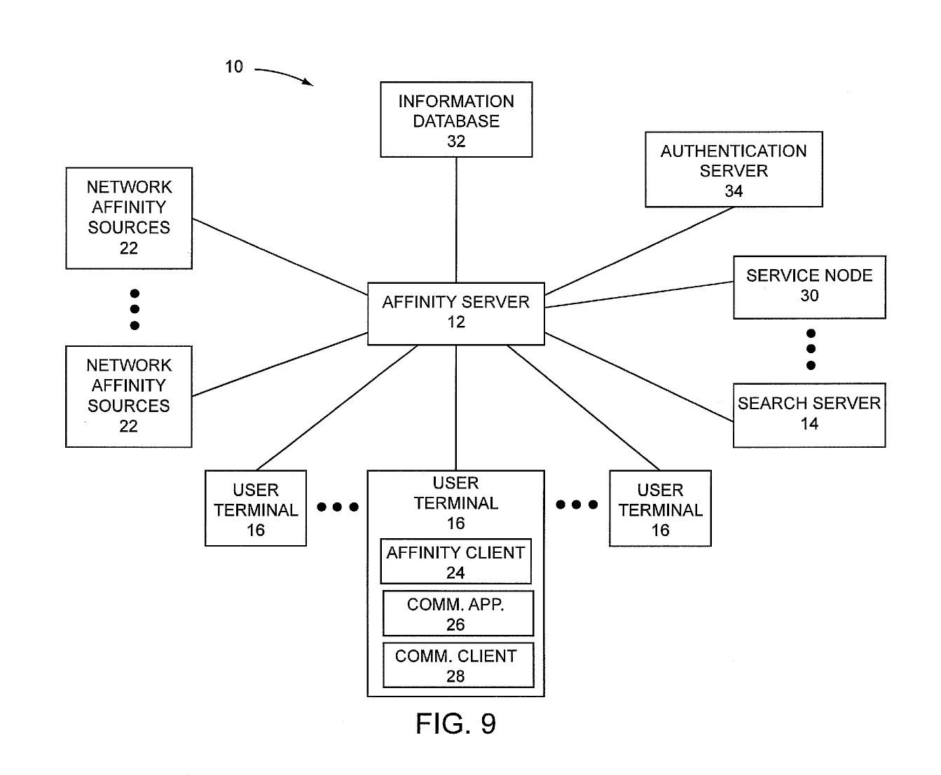

With reference to FIG. 9, another block representation of the communication network 10 is illustrated according to this embodiment. Residing in the communication network 10 is the affinity server 12, which will obtain affinity data for the user in association with communication events from one or more affinity sources, such as network affinity sources 22 for the user terminals 16, which may represent any type of communication terminal of various users or the contacts of the users. The network affinity sources 22 may represent instant messaging, email, virtual environment, location, or communication servers. In general, the network affinity sources 22 may represent any type of device that is affiliated with a communication event capable of providing affinity data in association with the communication event to the affinity server 12.

The user terminal 16 may include an affinity client 24, which is capable of interacting with the affinity server 12, communication applications 26, and a communication client 28. The affinity client 24 is a client that is configured to interact with the affinity server 12 on behalf of the user terminal 16. The affinity client 24 is used to relay local affinity data to the affinity server 12 and receive the affinity list for the user, as well as control or manage the affinity list for the user. Accordingly, the affinity client 24 may gather affinity data from communication applications 26 as well as provide the affinity list to the communication applications 26 for presentation to a user. The communication client 28 is used to facilitate such communications between the affinity client 24 and the affinity server 12. The communication client 28 may also facilitate general communications that are controlled by the communication applications 26. The communication applications 26 may include instant messaging, email, telephony, or like applications, wherein the communication client 28 facilitates the communications between the communication applications 26 and other entities in the communication network 10.

The block representation provided in FIG. 9 is logical in nature. In one embodiment, the affinity server 12 is centralized and is able to obtain affinity data and generate corresponding affinity lists for different users and provide these affinity lists to the corresponding user terminal 16 for the users. Although a centralized affinity server 12 will generally make it easier to obtain affinity data from various network affinity sources 22 as well as affinity sources within the user terminal 16, such as the communication applications 26, the affinity server 12 or a logical representation thereof may be implemented in a given user terminal 16 without departing from the concepts of this embodiment of the present invention.

In addition to providing affinity lists for a user to a user terminal 16 of the user, the affinity server 12 may provide the affinity list for a user to one or more service nodes 30. The service nodes 30 may represent various types of data consumers that will use the affinity list to provide various functions. The service nodes 30 may take various forms, including telephony or call servers, web servers, and the like. For the present invention, search servers 14 may represent one of the service nodes 30.

The affinity server 12 may also be able to access an information database 32, which may be configured to help normalize the affinity data obtained from different affinity sources. For example, different address or directory number formats for a given address or directory number may be provided by the different affinity sources. The affinity server 12 may access the information database 32 to obtain a standardized address or directory number to use when applying the ranking criteria and generating the affinity list. The normalization of information is not limited to addresses or directory numbers. When different types of communications are being used, the user may be associated with different user IDs, addresses, or the like. As such, the information database 32 may be able to standardize the user IDs, as well as keep track of the different types of communications associated with a given contact. An exemplary use of the information database 32 is provided further below. An authentication server 34 is also illustrated. The authentication server 34 may be used by the affinity server 12 to control or otherwise limit access to only authorized parties to control how affinity data is obtained and used, as well as to control how affinity lists are generated and distributed.

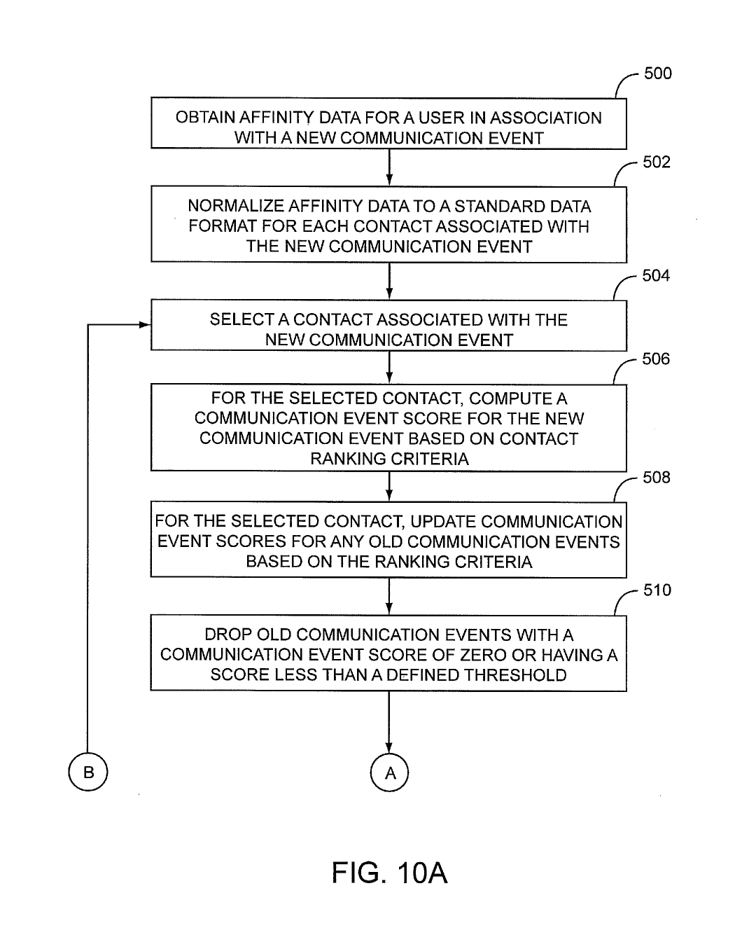

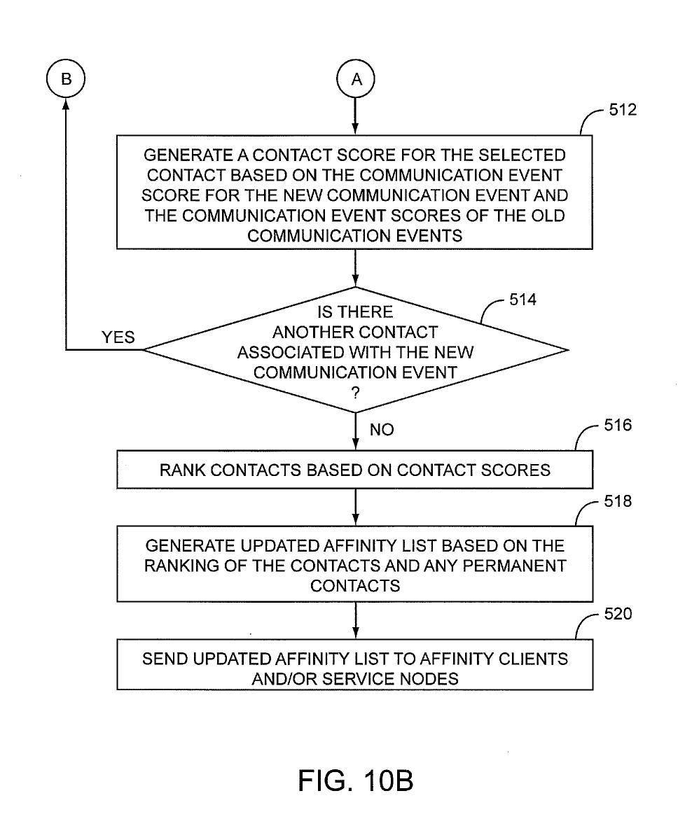

As indicated above, the affinity list for a user may be updated from time to time, wherein the contacts provided in the affinity list may change along with the order in which the contacts appear in the list. With reference to the flow diagram in FIGS. 10A and 10B, an exemplary process is provided for generating an updated affinity list in light of a new communication event. Initially, the affinity server 12 will obtain affinity data for a user in association with the new communication event (step 500). The affinity server 12 may access the information database 32 to effectively normalize the affinity data to a standard data format for each contact associated with the new communication event (step 502). If the communication event was associated with multiple communication contacts, the affinity server 12 will select a given contact associated with the new communication event (step 504), and for the selected contact, compute a communication event score for the new communication event based on the appropriate contact ranking criteria (step 506).

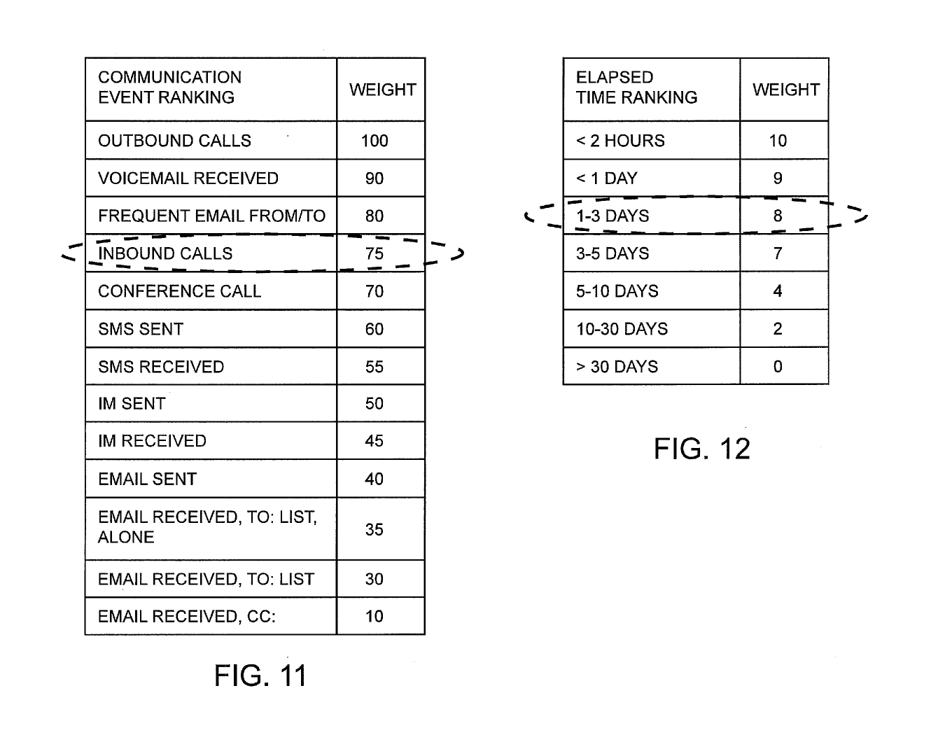

With reference to FIG. 11, a communication event ranking table is illustrated according to one embodiment of the present invention. The communication event ranking table identifies numerous communication events and provides a corresponding weight for each of the identified communication events. The listed communication events include initiating an outbound call, receiving a voicemail, participating in a frequent email exchange, receiving an inbound call, participating in a conference call, sending a short messaging service (SMS) message, receiving an SMS message, sending an instant message (IM), receiving an IM, sending an email, and receiving an email. Notably, there are three categories for receiving an email. The first category is associated with the user being the sole recipient of the email and identified in the “TO:” field. The second category is where the user is not the sole recipient of the email, but is listed in the “TO:” field. The third category is where the user is a recipient of the email, but is listed in the “CC:” field. For each of these communication events or scenarios, a different weight is assigned. The weight assigned to a particular communication event may make up part of the ranking criteria.

As illustrated in FIG. 12, additional ranking criteria may include the elapsed time since there was a communication in general or a particular type of communication involving a particular contact. The elapsed time ranking table of FIG. 12 includes seven categories that have different weights assigned to them. The first category is for communication events occurring within the last two hours, the second category includes communication events occurring within the last day, the third category includes communication events occurring between one and three days ago, the fourth category includes communication events occurring between three and five days ago, the fifth category includes communication events occurring between five and ten days ago, the sixth category includes communication events occurring between ten and thirty days ago, and the seventh category includes communication events that occurred more than thirty days ago. For ranking criteria that takes into consideration elapsed time, the different weights may be associated with the different categories. In this configuration, the greater the elapsed time, the less the weight associated with the communication event.

The computation of a communication event score for a new communication event may take place as follows in light of the event ranking and elapsed time ranking tables of FIGS. 11 and 12. Assuming the new communication event is an inbound call that occurred one and three days ago, a communication event score for the incoming call may be calculated by multiplying the weight associated with receiving an inbound call (75) with the weight associated with being involved in a communication event between one and three days ago (8) to arrive at a communication event score of 600 (75×8=600). Thus, for this example, the new communication event score for the incoming call that was received between one and three days ago is 600.

Continuing with the process illustrated in FIGS. 10A and 10B, the affinity server 12 will next update communication event scores for any old communication events, which include any communication events occurring prior to the new communication event, based on the ranking criteria for the selected contact (step 508). The affinity server 12 will analyze the old communication events, and drop any of the communication events that have a score of zero or have a score less than a defined threshold (step 510). Notably, the elapsed time ranking table of FIG. 12 provides a weight of zero (0) for communication events that occurred more than thirty days ago. Thus, regardless of the event ranking weight provided in FIG. 11 based on the type of communication event, the weighting of communication events that are greater than thirty days old are dropped from that particular contact in this example.

Throughout this process, the new and updated communication event scores are for different communication events involving the selected contact. As such, the affinity server 12 may have generated multiple communication event scores for the new communication event, and for any old communication events involving the selected contact. The affinity server 12 will then generate a contact score for the selected contact based on the communication event score for the new communication event and the communication event scores of any old communication events (step 512). At this point, an overall contact score for the selected contact is generated. In one embodiment, generating the contact score for a selected contact may simply include summing the communication event scores for each of the communication events associated with the selected contact. This process is repeated if there are other contacts associated with the new communication event (step 514). If there are no other contacts associated with the new communication event, or all of the contacts for the new communication event have been addressed (step 514), the affinity server 12 will rank the contacts based on their various contact scores (step 516).

Once the contacts are ranked, the affinity server 12 may generate an updated affinity list based on the ranking of the contacts, and importantly, any permanent contacts that are designated by the user or other entity (step 518). The permanent contacts may be associated with a default contact score, may be assigned a fixed or relative ranking, or the like, to ensure that they are included in the affinity list and perhaps at certain positions in the affinity list. Accordingly, contacts that are not permanent contacts are ranked as described above, and the permanent contacts are inserted into the ranking as desired when generating the affinity list. In addition to including permanent contacts in an affinity list, a user may instruct the affinity server 12 via the affinity client 24 to block certain contacts or communication events from being placed in the affinity list or being considered when generating the affinity list. Once generated, the affinity list is sent to the affinity clients 24 of the user terminals 16, the service nodes 30, or a combination thereof (step 520). This overall process may repeat as new communication events are received, after a certain number of communication events have been received, on a periodic basis, or the like. Those skilled in the art will recognize numerous variations of the underlying concepts of the present invention. These variations are all deemed to be within the scope of the present invention.

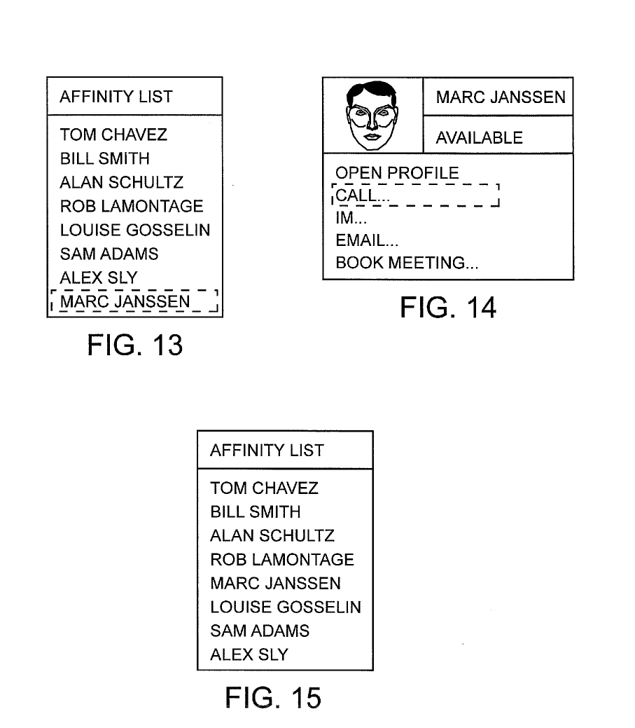

With reference to FIG. 13, an exemplary affinity list is illustrated to include Tom Chavez, Bill Smith, Alan Schultz, Rob LaMontage, Louise Gosselin, Sam Adams, Alex Sly, and Marc Janssen. Assume the affinity list is prioritized from top to bottom, wherein Tom Chavez is ranked highest, and Marc Janssen is ranked lowest in the affinity list. In one embodiment, the affinity client 12 is capable of cooperating with the communication applications 26 and the communication client 28 to effectively provide the affinity list to the user in association with viewing a particular application. In this example, the application allows the user to initiate various types of communications by selecting a name within the affinity list.

In this example, assume the user selects Marc Janssen, and such selection results in the presentation of the window illustrated in FIG. 14 to the user. The window may include Marc Janssen's name, photograph, and pertinent presence information, which indicates the relative availability of Marc Janssen for communications. The window may also include options to open a profile associated with Marc Janssen, initiate a call, instant message, or email to Marc Janssen, as well as book a meeting or send a calendar invite to Marc Janssen. In this instance, assume that the user elects to initiate a call to Marc Janssen. The call to Marc Janssen is a communication event, which will ultimately be analyzed by the affinity server 12 as described above. Assuming there are no other communication events before an updated affinity list is generated, the initiation of a call to March Janssen will inevitably increase the contact score for Marc Janssen relative to the contact scores of the other contacts in the affinity list. As such, the rankings of the contacts in the affinity list will change, as represented in FIG. 15. In FIG. 15, Marc Janssen has moved up in the affinity list, and as such, represents a contact of higher relevance in the updated affinity list with respect to the original affinity list (FIG. 13).

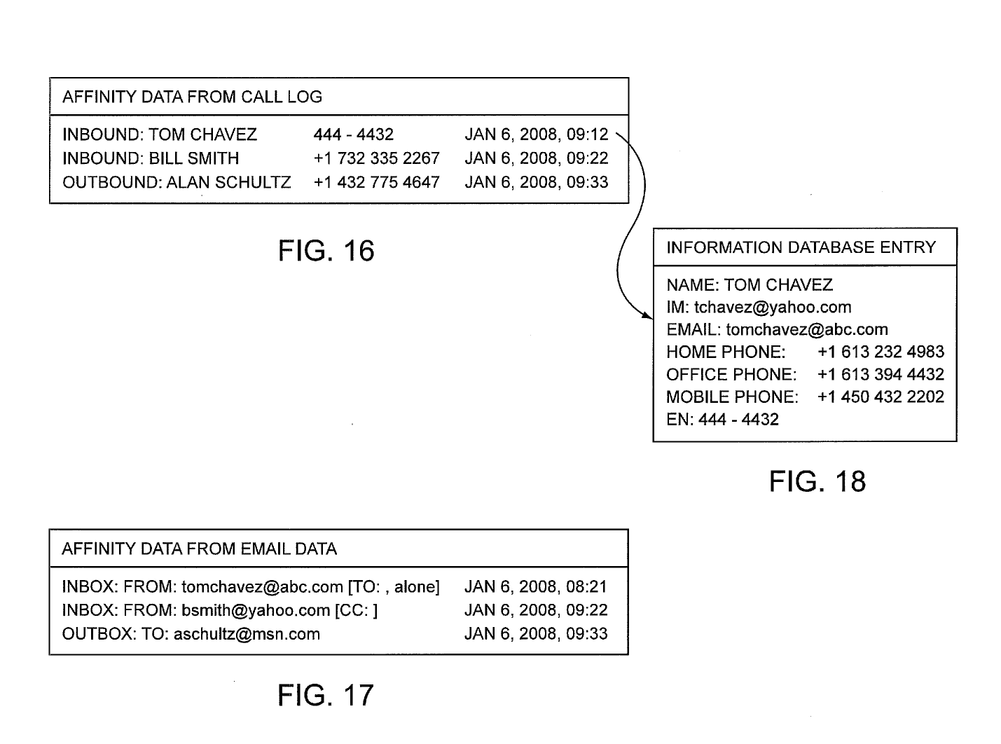

FIGS. 16 and 17 provide examples of affinity data from a call log and email data, respectively. With particular reference to FIG. 16, the affinity data from a call log may identify the inbound and outbound calls that were logged for a user. Each logged call may indicate whether the call was an inbound call or an outbound call, as well as provide the name, date, time, and number associated with the respective calls. Having access to call log information allows the affinity server 12 to identify those parties with whom the user has communicated, as well as provide various types of affinity data to assist in determining where to rank the identified contacts in the affinity list for the user.

Turning now to FIG. 17, the affinity data from email data may include various types of information. This information may identify whether the email was an incoming or outgoing email, the party from whom the email was received, the party to whom the email was sent, or a corresponding email address. The affinity data may also include the time and date associated with receiving or sending the email, as well as the nature of the email. As illustrated, the affinity data for the incoming emails from tomchavez@abc.com and bsmith@yahoo.com indicate whether the user was identified in the “TO:” field, “CC:” field, or “BCC:” field (not shown). Emails where the user is in the “TO:” field may be associated with a higher communication event score than email where the user is in the “CC:” field. Further, the affinity data from the email data may indicate whether the user was the only one to receive the email, or was part of an extended list of users that received the email. Armed with this information, the affinity server 12 may associate a higher communication event score for incoming emails where the user is the only recipient of the email. Those skilled in the art will recognize other affinity data that may be processed for various types of communications and deemed beneficial in determining the relevance of the communication with regard to determining a relative ranking of communication events and the contacts associated therewith.

With reference to FIG. 18, an information database entry is illustrated. The information database entry may be maintained for various contacts in the information database 32, and made accessible to the affinity server 12, or may be maintained in the user terminal 16, wherein the functionality of the affinity server 12 is provided therein. Preferably, the information database 32 maintains a normalized entry for available contacts, wherein consistent name and communication information is maintained. The information database entry may provide the normalized information for a particular contact, in this case Tom Chavez, and all of the normalized communication information for Tom Chavez. The information database entry may also keep track of known variants in such information that aid in providing the normalized information back to the affinity server 12 in response to the affinity server 12 providing one of the variants to the information database 32. For example, the call log information for Tom Chavez, as illustrated in FIG. 16, identifies the directory number for Tom Chavez as an enterprise directory number (EN), 444-4432. However, the enterprise directory number is only useful for users being served by an enterprise network. Users outside of the enterprise network must dial a full directory number, such as the directory number associated with Tom Chavez's office. Tom Chavez's office number, as illustrated in FIG. 18, is +1 613 394 4432, which corresponds to the enterprise directory number 444-4432. The information database entry associated with Tom Chavez will allow the affinity server 12 to access the information database entry using the enterprise number as well as the office phone number, and alert the affinity server 12 that both numbers correspond to the same contact as well as the same telephone of that contact. Accordingly, the internal enterprise directory number and the external directory number associated with Tom Chavez's phone number are normalized to the external directory number for the purposes of determining Tom Chavez's relative rank in the affinity list.

From the above, this embodiment of the present invention is capable of analyzing communication interactions with various contacts to create a ranked list of those contacts. In one embodiment, communications with a single contact using different types of communication techniques may be taken into consideration for determining the relative ranking of the contact in an affinity list. As such, a comprehensive listing of the contacts in the form of an affinity list can be provided for a user. Further, the affinity list may be updated to take into consideration the evolution of communications and the contacts involved in those communications.

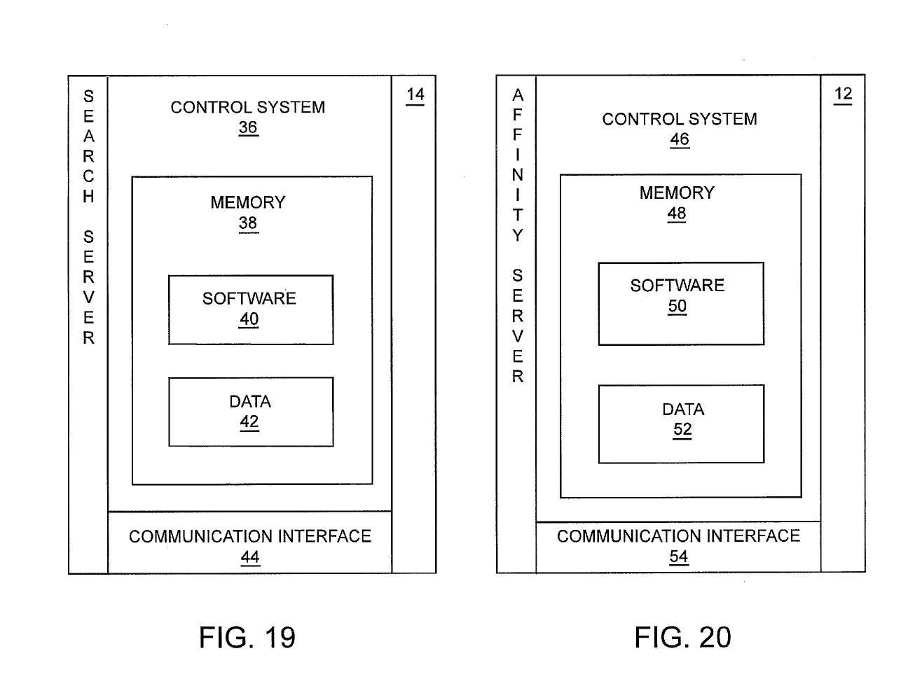

With reference to FIG. 19, a block representation of a search server 14 is provided. The search server 14 may include a control system 36 and sufficient memory 38 for the requisite software 40 and data 42 to operate as described above. The control system 36 may also be associated with a communication interface 44 to facilitate communications with the various entities that are illustrated in FIGS. 2 and 9.

With reference to FIG. 20, a block representation of an affinity server 12 is provided. The affinity server 12 may include a control system 46 and sufficient memory 48 for the requisite software 50 and data 52 to operate as described above. The control system 46 may also be associated with a communication interface 54 to facilitate communications with the various entities that are illustrated in FIGS. 2 and 9 as well as with any other entities from which affinity data may be obtained or an affinity list may be provided.

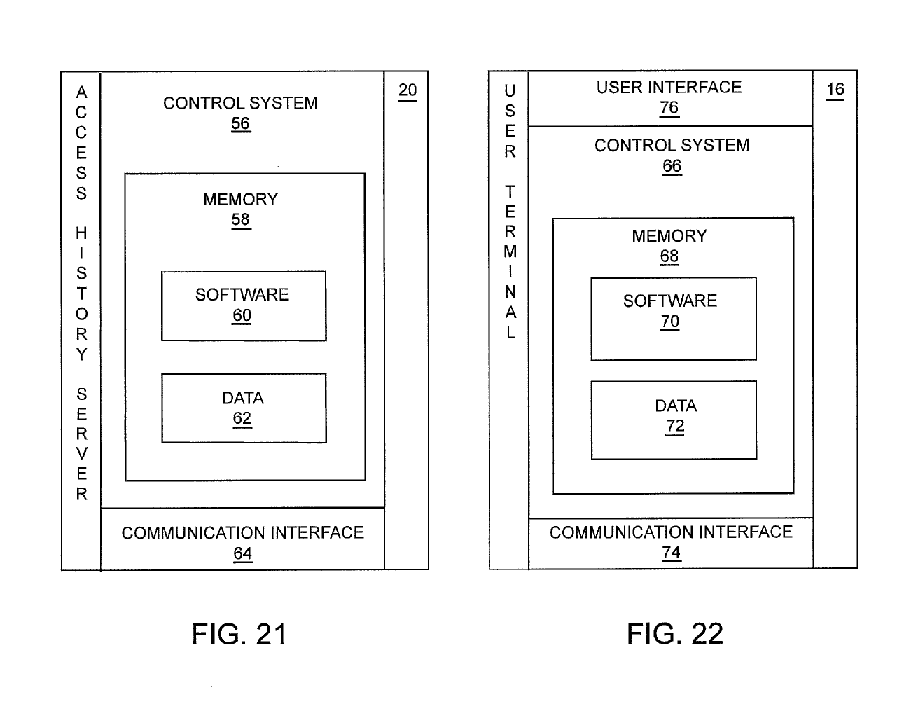

With reference to FIG. 21, a block representation of an access history server 20 is provided. The access history server 20 may include a control system 56 and sufficient memory 58 for the requisite software 60 and data 62 to operate as described above. The control system 56 may also be associated with a communication interface 64 to facilitate communications with the various entities that are illustrated in FIGS. 2 and 9 as well as with any other entities from which access history information may be obtained or provided.

With reference to FIG. 22, a block representation of a user terminal 16 is illustrated. The user terminal 16 may include a control system 66 having sufficient memory 68 for the requisite software 70 and data 72 to operate as described above. The control system 66 may be associated with a communication interface 74 as well as a user interface 76 to facilitate communications with various network entities and provide a traditional interface with a user, respectively. Depending on the embodiment, the user terminal 16 may support one or more of the affinity client 24, the communication applications 26, and the communication client 28. The affinity client 24 may be configured to interact with the affinity server 12 to provide affinity data, as well as receive an affinity list. In another embodiment, the affinity client 24 may be configured to provide the functionality of the affinity server 12, and as such, may be able to gain affinity data from communication applications 26 as well as from the network affinity sources 22 or the external affinity server 12. Those skilled in the art will recognize the flexibility in allocating or distributing the affinity functionality within or between the affinity server 12 and the user terminal 16.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving a search query from a user who is associated with an affinity list, which comprises a list of contacts of the user;
conducting a search based on the search query to obtain a plurality of content items responsive to the search query; and
ranking at least a portion of the plurality of content items based on affinity criteria that bears on those content items that have been accessed by the contacts of the user.

2. The method of claim 1 further comprising obtaining the affinity criteria, wherein the affinity criteria comprise access history information that identifies those content items that have been accessed by the contacts of the user and wherein the at least a portion of the plurality of content items is ranked based on the access history information.

3. The method of claim 2 wherein the access history information comprises information specifically identifying which of the plurality contacts accessed each of those content items that have been accessed by the contacts of the user.

4. The method of claim 2 wherein the access history information further identifies a number of times certain of those content items that have been accessed by the contacts of the user have been accessed, and wherein the at least a portion of the plurality of content items is ranked based on the number of times the certain content items have been accessed.

5. The method of claim 1 further comprising obtaining the affinity criteria, wherein the affinity criteria comprise for each of the contacts of the user unique access history information that identifies those content items that have been accessed by each of the contacts of the user and wherein the at least a portion of the plurality of content items is ranked based on the unique access history information for each user.

6. The method of claim 1 further comprising obtaining the affinity criteria, wherein the affinity criteria comprise access history information that identifies a nature in which those content items that have been accessed by the contacts of the user were accessed and wherein the at least a portion of the plurality of content items is ranked based on the nature in which those content items have been accessed by the contacts of the user.

7. The method of claim 1 further comprising obtaining the affinity criteria, wherein the affinity criteria comprise access history information that identifies when those content items that have been accessed by the contacts of the user were accessed and wherein the at least a portion of the plurality of content items is ranked based on the when those content items have been accessed by the contacts of the user.

8. The method of claim 1 wherein the contacts in the list of contacts comprise contacts with which the user has communicated.

9. The method of claim 1 wherein the contacts in the list of contacts comprise contacts with which the user is likely to communicate.

10. The method of claim 1 wherein the contacts in the list of contacts consist of at least one of contacts with which the user has communicated and contacts with which the user is likely to communicate.

11. The method of claim 1 wherein the contacts in the list of contacts of the affinity list are ranked and the at least a portion of the plurality of content items are further ranked based on rankings of the contacts in the list of contacts.

12. The method of claim 11 wherein at least certain of the contacts in the list of contacts are ranked based on communications with the user.

13. The method of claim 11 wherein the rankings of the at least certain of the contacts in the list of contacts are dynamically updated based on the communications with the user.

14. The method of claim 11 wherein the rankings of at least certain of the contacts in the list of contacts are substantially static.

15. The method of claim 1 wherein the at least a portion of the plurality of content items is further ranked based on ranking criteria that is unrelated to the affinity criteria.

16. The method of claim 1 further comprising:
determining whether to use the affinity criteria for ranking the at least a portion of the plurality of content items; and
when the affinity criteria is not to be used, ranking the at least a portion of the plurality of content items based on ranking criteria that is unrelated to the affinity criteria, wherein when the affinity criteria is to be used, the least a portion of the plurality of content items is ranked based on the affinity criteria.

17. The method of claim 16 further comprising receiving input from the user bearing on whether to use the affinity criteria and determining whether to use the affinity criteria for ranking the at least a portion of the plurality of content items based on the input.

18. The method of claim 17 wherein the input from the user is received with the search query.

19. The method of claim 1 wherein the search is conducted over the Internet.

20. The method of claim 1 wherein the search is conducted within a corporate intranet.

21. The method of claim 1 wherein certain of the plurality of content items comprise one of a group consisting of web pages, word processing documents, spreadsheets, and presentations.

22. The method of claim 1 wherein certain of the plurality of content items comprise one of the group consisting of audio, video, voice, and image files.

23. The method of claim 1 further comprising authenticating the user prior to conducting the search.

24. The method of claim 1 wherein an indication to rank search results provided in response to the search query based on the affinity criteria is received in association with the search query, and ranking the at least a portion of the plurality of content items based on the affinity criteria is conditioned on receiving the indication.

25. A method comprising:
conducting a search based on a search query to obtain a plurality of content items responsive to the search query from a user who is associated with an affinity list, which comprises a list of contacts of the user;
identifying accessed content items that have been accessed by the contacts of the user, wherein the plurality of content items responsive to the search query comprise certain of the accessed content items; and
ranking at least a portion of the plurality of content items based on the certain the accessed content items.

26. A system comprising:
at least one communication interface; and
a control system associated with the at least one communication interface and adapted to:
receive a search query from a user who is associated with an affinity list, which comprises a list of contacts of the user;
conduct a search based on the search query to obtain a plurality of content items responsive to the search query; and
rank at least a portion of the plurality of content items based on affinity criteria that bears on those content items that have been accessed by the contacts of the user.
